(19) United States
(12) Patent Application Publication
(10) Pub. No.: US 2014/0059113 A1
(43) Pub. Date: Feb. 27, 2014

(54) Dynamically Reconfigurable Event Monitor and Method for Reconfiguring an Event Monitor

(71) Applicant: Christopher R. Adams, Brooklyn, NY (US)

(72) Inventor: Christopher R. Adams, Brooklyn, NY (US)

(21) Appl. No.: 13/590,267

(22) Filed: Aug. 21, 2012

(51) Int. Cl. G06F 15/16

(52) U.S. Cl. 709/203

(57) ABSTRACT

The invention provides an event filter including a filter input configured to receive a plurality of events provided by at least one mobile computing device. The filter passes events from the event filter input to a filter output in accordance with a configuration signal provided by a client system. An event counter is configured to provide a count of the events passed by the event filter. A message unit includes an input for receiving the count provided by the event counter and an input for receiving alerts provided by the client system. The message unit stores the alerts and returns the stored alerts to the client system whenever the count provided by the event counter reaches the count provided by the client system.

### FIELD OF THE INVENTION

The present invention relates generally to event monitors and methods for event monitoring in computing devices and more particularly to reconfigurable event monitors and methods for reconfiguring event monitors in networks comprising mobile computing devices.

### BACKGROUND OF THE INVENTION

The demand for interactive mobile applications (‘apps”) in i-Pads and other mobile computing devices is growing rapidly. Enterprises increasingly rely on apps to differentiate their products and services from those of their competitors. Mobile applications also serve as tools for engaging customers, reinforcing brand value and improving customer service.

In the context of mobile computing devices, the term ‘event monitoring’ refers to observing, recording and analyzing various events that occur as device users interact with mobile devices and mobile applications. Events may be collected, recorded and analyzed for various purposes. For example, analysis of application related events collected from a plurality of devices running the application over a period of time can provide valuable information about application usage patterns, response times, quality of service and many other types of information.

Conventional event monitoring techniques call for mobile devices to be equipped with corresponding event platforms.. Events are defined for a given mobile computing event platform to correspond to certain device actions or state changes. The actions are ‘fired’ when their corresponding events occur. An event firing is detected by a corresponding event listener who notifies a corresponding event handler. The corresponding event handler may be programmed to process information about the event it receives from the event listener. The event notification and corresponding event information may then be transmitted to a centralized server. The server may receive event notifications and event data from a plurality of respective corresponding event handlers, each reporting events ‘firing’ on their respective devices. The event data from the plurality of devices is typically collected and stored in a database for later analysis.

The information gained from analyzing events gathered by conventional event monitors is valuable. However, conventional event monitors have limitations in that the number and type of event they monitor is fixed before runtime and typically cannot be changed once a device and its applications are deployed and operational.

Further conventional event monitors do not provide define events for certain types of information, such as patterns of event firings or repetitive firings of the same event. In many cases it would be desirable to be able to detect firing patterns of certain events and to detect repetitive firings of the same event. It would further be desirable to have the capability to define new events based on firing patterns of existing events or on repetitive firing of an existing event.

Event monitors and methods are needed that would enable application developers, network administrators, mobile device managers and others to monitor and respond to events or event patterns as these occur during run time by dynamically (during run time) reconfiguring an event monitor to listen to certain events and to detect patterns and repetitive firings of the certain events, and to define and receive during run time customized reports related to occurrences of the additional events. System and methods are desirable that would allow an event monitor to be reconfigured during run time in accordance with client-defined event reporting criteria.

Further needed are systems and methods enabling application developers, business managers and others to adjust or refine certain event information in order to collect information that would enable effective management of application programs deployed in fleets of mobile devices.

### SUMMARY OF THE INVENTION

The invention meets the need above by providing an event filter including a filter input configured to receive a plurality of events provided by at least one mobile computing device. The filter passes events from the event filter input to a filter output in accordance with a configuration signal provided by a client system. An event counter is configured to provide a count of the events passed by the event filter. A message unit includes an input for receiving the count provided by the event counter and an input for receiving alerts provided by the client system. The message unit stores the alerts and returns the stored alerts to the client system whenever the count provided by the event counter reaches the count provided by the client system.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a high level block diagram of a dynamically reconfigurable event monitor according to an embodiment of the invention;

FIG. 2 is a block diagram illustrating further details of an embodiment of the dynamically reconfigurable event monitor illustrated in FIG. 1;

FIG. 3 is a block diagram illustrating further details of an event receiver of the type illustrated in FIGS. 1 and 2 according to an embodiment of the invention;

FIG. 4 is a block diagram illustrating an event filter of a type illustrated in FIGS. 1 and 2 according to an embodiment of the invention ;

FIG. 5 is a block diagram illustrating a request receiver of a type illustrated in FIG. 2 according to an embodiment of the invention;

FIG. 6 is a block diagram illustrating a message unit of a type illustrated in FIG. 1 according to an embodiment of the invention;

FIG. 7 is a flow chart of a method for receiving events according to an embodiment of the invention;

FIG. 8 is a flowchart illustrating an example method for counting events according to an embodiment of the invention;

FIG. 9 is a flowchart illustrating a method for configuring an event monitor according to an embodiment of the invention;

FIG. 10 is a block diagram of an example client system suitable for use with various embodiments of the invention;;

FIG. 11 is a block diagram of a mobile computing device suitable for use with various embodiments of the invention.

### DETAILED DESCRIPTION OF THE INVENTION

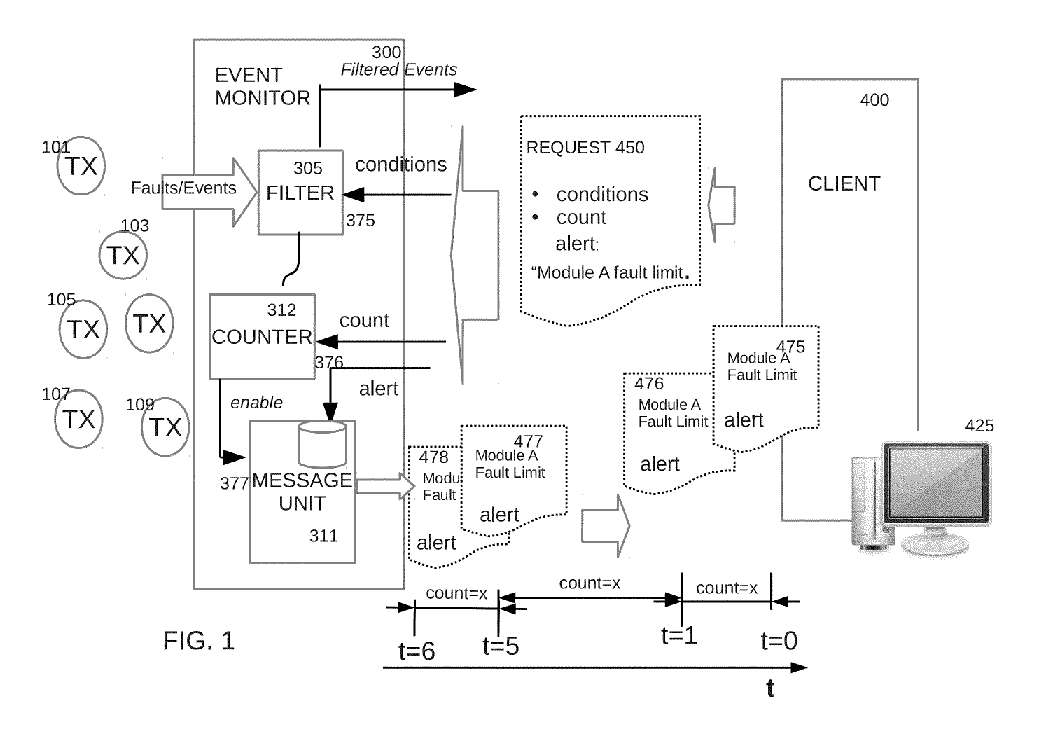

### FIG. 1

FIG. 1 is a simplified block diagram of a dynamically reconfigurable event monitor 300 deployed to receive and store event notifications generated by a plurality of devices 101-109. For convenience of illustration and discussion, only a few devices are illustrated in FIG. 1 and in the remaining drawing figures contained herein. However, it will be understood the number of devices communicating events to event receiver 302 is not limited to any specific number. As few as one device may comprise network 10. On the other hand, embodiments of network 10 are envisioned comprising more than 1000 devices. These remain within the scope of the invention disclosed and claimed herein.

Each device 101-109 is equipped with a corresponding event detection and notification platform. When a device event platform detects an event associated with the device, the event detection and notification platform transmits a corresponding notification to event monitor 300. An event notification includes an indication of the type of event that occurred for example, a program event, a hardware event, a user event, etc. In some configurations, a single event type may include a plurality of different specific events within its scope. For example, the events “volume”, ON/OFF and “Antenna” may all be events of the type ‘hardware event’. In that case the notification may include an indication of the event type and may further identify a specific event of that type as the event which took place.

Even monitor 300 comprises an event filter 305, an event counter 312 and a message unit 311. Event filter 305 receives at a filter input the plurality of events transmitted by devices 101-109. Event filter 305 filters the input events such that only a subset of the events is passed to an output of filter 305.

A counter 312 counts the filtered events appearing at the output of filter 305. Counter 12 provides an enable signal to message unit 311 based on the event count. Message unit 311 stores messages comprising alerts to be provided to client 400. various types at a filter input. Each time message unit 311 receives an enable signal from counter 312, message unit 311 provides an alert to client system 400.

Filter 305, counter 312 and message unit 311 each operate in accordance with a corresponding control signals provided at its input. Thus filter 305 filters events received from transmitters 109-111 in accordance with the control signal “conditions” at event filter input 375. Likewise, counter 313 counts upwards to the value provided by the “count” control signal at input 376. Message unit 311 provides messages to client unit 400 whenever the “enable” signal it input 377 is activated.

Control signals “conditions” and “count” are defined by client system 400. In other words an operator of client system 400 determines filter conditions and a corresponding counter count and provides the determined condition and count to event monitor 400 in correspondingly marked portions of a request 450. Client system 400 provides request 450 to event monitor 300.

Event monitor 300 receives the request and evaluates the markings. Based on the marking evaluation event monitor provides the client-requested “conditions” to input 375 of filter 305. Event monitor 305 provides the client-requested “count” to count input of counter 312.

Client system 400 is further capable of defining the alerts to be stored in message unit 311. To accomplish this, client system 400 provides alert text, for example “Module A fault limit” in a corresponding appropriately marked portion of request 450. Event monitor 300 evaluates the received request 450 and provides any alert text from the corresponding marked portion of request 450 to message unit 311. Message unit 311 receives the request and stores it.

Using request 340, client system 400 can configure event monitor 300 to operate on received events in accordance with instructions provided by client 400. Client 400 can further utilize request 450 to configure event monitor 300 to return messages defined and provided by client 400 as event monitor 300 operates on received events.

Client 400 can provide more than one requests 450 to event monitor 300. Each request can define a different corresponding configuration for event monitor 300. Thus event monitor 300 is configurable and reconfigurable to monitor events in accordance with instructions from client system 400 and to report results defined by client system 400 to client system 400.

In one example embodiment events received by event monitor 300 comprise information related to faults, or failures, occurring in devices comprising transmitters 101-109. In the example, a variety of faults may arise in any of a plurality of modules comprising each corresponding transmitter 101-109. For example, assume an example module, Module A, can suffer from any one or more of three possible hardware type faults, a power failure (PF), an over-temperature condition Tc, and an interlock condition LCK.

Client 400 has deployed transmitters 101-109 in a high temperature environment at a location X. Client 400 would like to automatically receive a report every time an over-temperature event takes place in any of transmitters 101-109 as they operate in the environment. In that case, client 400 generates a request wherein “condition” is set to Tc (indicating over temperature events). “Count” is set to 1. (A report is returned to client 400 every time an over-temperature event takes place.) The client places the following text in the “alert” portion of request 400: “Temperature event Tc at location X”. Client 400 provides the request 450 to event monitor 300.

Event monitor 300 receives the request 450. Event monitor 300 provides the “conditions” portion of request 450 (Tc) to filter 305. In response, filter 305 passes only Hardware events comprising over-temperature conditions (Tc) from its input to its output.

Even monitor 300 provides the “count” portion (1) of request 450 to counter 312. The first time counter 312 detects an output of filter 305 (tc) , counter 312 increments by 1 from 0 to 1. The contents of counter 312 are compared to “count” at input 376 of counter 312. Because the value of “count” at input 312 is 1, it matches the value of counter 312 after incrementing. As a result, counter 312 provides an “enable” signal to message unit 311.

Event monitor 300 provides the “alert” portion of request 450 to message unit 311 where it is stored until dispatched. The alert portion in the present example comprises: “Temperature event at location X”. Message unit 311 receives the enable signal provided by counter 312. In response message unit 311 provides the alert “Temperature event Tc at location X” to client system 400.

Each time an alert is dispatched from message unit 311, counter 312 is reset to a reference count. In the present example the reference count is 0. The next time filter 305 detects an over-temperature event Tc among the events at its input, the chain of events described above repeats and client 400 is provided with the same alert.

The configuration signals provided to components of event monitor 300 persist until a new request comprising different configuration signals is received by event monitor 300.

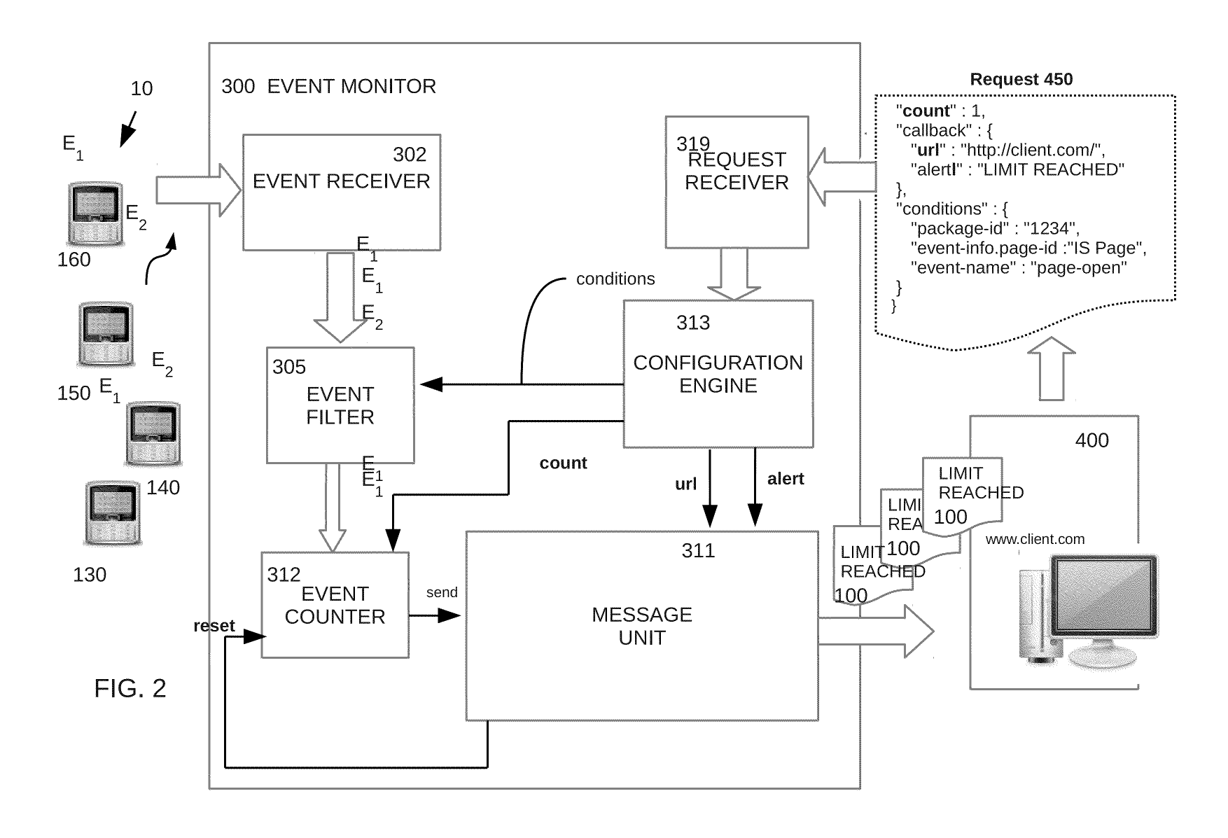

### FIG. 2

FIG. 2 is a block diagram illustrating further details of an event monitor 300 of the type illustrated in FIG. 1 at 300. In the example embodiment illustrated in FIG. 2, event monitor 300 is deployed within a network 10 comprising a fleet of mobile computing devices 130, 140, 150 and 160. Event monitor 300 includes a ‘front-end’ network interface comprising an event receiver 302 and a ‘back-end’ network interface comprising a request receiver 319. Event receiver 302 is configured to receive event notifications from mobile computing devices 130, 140, 150 and 160 via a network front end comprising a wireless communication network interface. Request receiver 319 is configured to receive requests from a client system 400 via a network back end comprising a wide area network interface such as an Ethernet adapter configured for communication via the Internet.

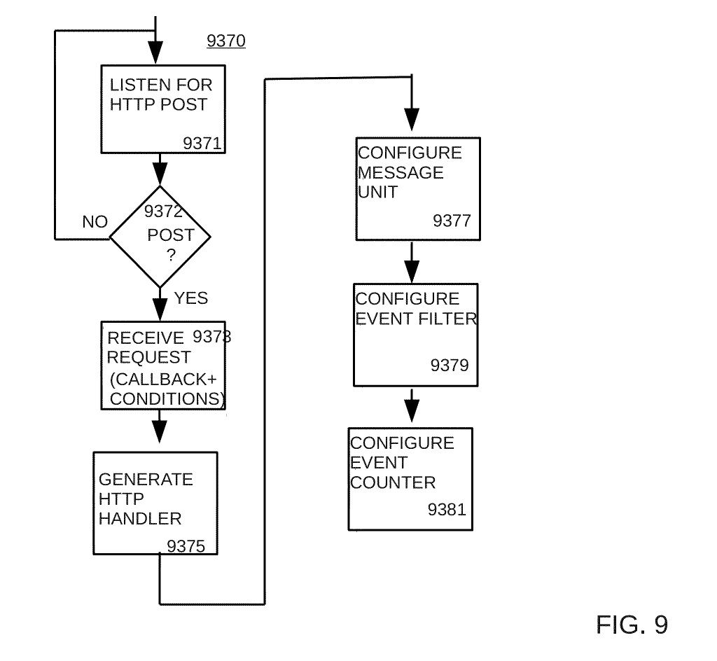

A request receiver 319 listens over a port of network back end of Event Monitor 300 for HTTP POSTs. (See FIG. 9 at 371.) Requests 450 are provided to Event Monitor 300 when client 400 initiates an HTTP post request. The HTTP POST comprising request 450 includes a callback element and a conditions element. A POST from client 400 is detected by request receiver 319. (See FIG. 9 at 9372.) Pursuant to detecting an HTTP POST request receiver 319 receives request 450. (See FIG. 9 at 9373.)

In response to receiving request 450 from client 400, request receiver 319 generates, or ‘spawns’ an HTTP handler comprising configuration engine 313. (See FIG. 9 at 9375.) Configuration engine 313 parses request 450. For example configuration engine 313 provides an ‘alert’ element comprising request 450 to an input of a message unit 311. Message unit 311 is configured in accordance with the alert input to compose a return message (for example “LIMIT REACHED” illustrated at 100 in FIG. 2) (See FIG. 9 at 9377). The return message 100 including the client-defined ‘alert’ is provided to client 400.

A ‘URL’ element comprising request 450 is provided by configuration engine 313 to another input of message unit 311, thus configuring message unit 311 to address the message including ‘alert’ to the URL defined by the client in request 450. (See FIG. 9 at 9377)

A ‘count’ element of request 450 is provided by configuration engine 313 to an event counter 312. Thus event counter 312 is configured to count in accordance with the count defined by client 400 using message 450. (See FIG. 9 at 9381.) A ‘conditions’ element of request 450 is provided by configuration engine 313 to a configuration input of event filter 305. Thus event filter 305 is configured to filter events E at its input in accordance with client-defined conditions to provide a filtered output. (See FIG. 9 at 9379)

Event counter 312 counts the events at the output of event filter 305. When a number of events at the output of filter 305 is the same a client defined ‘count’, event counter 312 provides a ‘send’ command to message unit 311. Message unit 311 responds to the send command from event counter 312 by providing a message 100 to client 400. The message 100 is sent to client 400 at the address comprising the URL element of the callback comprising message 450.

### Mobile Computing Devices 130,140,150,160

Distinguished from Desktop/Laptop

For purposes of this specification the term ‘mobile computing device’ refers to any computing device capable of being operated while being transported. Such devices include, but are not limited to Netbooks, Smart-books, Tablets, e-Readers, i-Pads, smart-phones, personal digital assistants and the like.

Differences exist between mobile communication devices and conventional computing devices such as desktops and laptops. The differences stem from the demand that mobile devices be easily portable, multi-functional, battery operable, low in power consumption and operable while being ported. The requirement to be small lightweight and operable while being ported lead to the rise in popularity of the touchscreen as a preferred user interface device for mobile computing.

The input means for mobile computing devices is not the only characteristic distinguishing laptop and desktop computers from mobile computing devices. Due to constraints on their size and power consumption, mobile computing devices frequently rely on processors that differ in many respects from processors found in laptop and desktop computers. For example, many mobile computing devices employ Reduced Instruction Set Computing (RISC) processors. These processors offer much lower power consumption than alternative architectures and deliver performance approaching that of some desktops and laptops. Further differences are associated with integrated touch-screens found on mobile computing devices as the primary input output device. Further, mobile computing devices rely predominantly on wireless technologies for communication and data transfer.

Accordingly technical approaches to hardware and software event detection and notification can differ significantly between mobile computing devices and conventional desktop and laptop devices. These differences call for approaches to system design and programming for mobile computing devices that differ from those used with conventional laptop and desktop computers.

### FIG. 11

FIG. 11 illustrates an example mobile computing device 130 suitable for use with embodiments of the invention. For ease of discussion one representative mobile computing device 130 will be described below. However, the description of device 130 is equally applicable to additional mobile computing devices comprising a network of mobile computing devices.

Mobile computing device 130 comprises at least one processor 100 configured to execute program instructions and to respond to inputs received from a device user via an input output (I/O) subsystem 150. In a typical configuration I/O subsystem 150 cooperates with a touch screen controller 157. Touch-screen controller 157 is coupled to a touch screen display device 158. Touch screen controller 157 responds to user contact with display screen 158. Display screen 158 may be implemented using any of a plurality of touch sensitive technologies. These include, but are not limited to capacitive, resistive, infrared, and surface acoustic wave technologies, as well as other proximity sensor arrays or other elements for determining one or more points of contact of a human user with the screen of touch screen display 158.

Other input devices are suitable for use with embodiments of the invention. These include but are not limited to stylus, mouse, keyboard, buttons, rocker switches, thumb-wheel, infrared port, USB port, and/or pointer devices (not shown). The one or more buttons typically include an up/down button cooperating with an audio subsystem 155 for volume control of a speaker and/or microphone (not shown).

Processor 100 is further configured to execute instructions to control a non-volatile storage unit 104. Non volatile storage unit 104 comprises application programs received for example, by downloading the programs via network interface 112. Non volatile storage unit 104 may also store programs pre-loaded by a device manufacturer or developer. Suitable non volatile storage units 104 include those implemented in Read Only Memory (ROM), Erasable Programmable Read Only Memory (“EPROM”), and Flash Memory to name but a few examples.

Processor 100 cooperates with an operating system 166 to execute instructions comprising applications, or ‘apps’ stored in non volatile storage 104 of mobile computing device 130. Accordingly, mobile computing device 130 is equipped with one of a plurality of commercially available mobile device operating systems. Suitable operating systems to comprise operating system 166 include, but are not limited to Android, iOS, BlackBerry OS, Bada, Linux, Palm OS, Symbian, WebOS, Windows Mobile and Windows Phone.

Operating system 166 comprises instructions for handling basic system services and for performing hardware dependent tasks. In some implementations, operating system 166 can include a kernel (e.g., UNIX kernel).including portions responsive to input provided by a device user via I/O subsystem 150.

In addition to operating system 166 an example embodiment includes at least one client application 128 such as an email application, a contact manager application , a calendar application , an instant messenger application or the like. Application Program Interface

According to some embodiments of the invention processor 100 is configured to execute instructions comprising an Application Program Interface (API). An API typically defines at least one parameter that is passed between a calling application and other software code. For example, a parameter may be passed between a calling application and an operating system, a library routine or a function that provides a service or data, or that performs an operation or a computation. An API can be implemented as one or more calls in program code that send or receive one or more parameters through a parameter list or other structure based on a call convention defined in an API specification document.

In some implementations, an API call can report to an application the capabilities of a mobile computing device 130 running the application, such as input capability, output capability, processing capability, power capability, communications capability, etc. These capabilities can, in turn, be provided to notification gateway 300 and provided in connection with event information to a requesting client 400.

The instructions comprising applications are typically maintained persistently in non-volatile storage unit 104 and executed by processor 100. Processor 100 may also rely on volatile storage 108 during the execution of program instructions stored in non-volatile storage unit 104. Processor 100 is typically further configured to control a display 158, and speaker 166 in accordance with appropriate corresponding programming instructions.

Processor 100 is further coupled to a network interface device 112. Network interface device 112 includes at least one radio frequency (RF) communications device configured to communicate with a communication subsystem 301 of notification gateway 300 over a wireless communication link. Network interface 112 includes input/output functions that can be controlled by processor 100 to carry out various communication related tasks.

The specific design and implementation of network interface 112 of mobile computing device 130 and of communication subsystem 301 of notification system 130 will vary in accordance with the communication network(s) over which mobile device 130 and notification system 300 intended to communicate. For example, network interface 112 of mobile device 130 and communication subsystem 301 of notification gateway 300 can be configured to communicate over a GSM network, a GPRS network, an EDGE network, a Wi-Fi or WiMax network, or a Bluetooth network.

In some embodiments of the invention, network interface 112 is configured to host protocols enabling mobile computing device 130 to serve as a base station for other mobile computing devices comprising network 10. Any RF system configuration comprising a network interface 112 configured in accordance with the network architecture defining an operative communication link between notification gateway 300 and mobile computing device 130 will be suitable for implementing various embodiments of the invention. Nonetheless, it should be noted mobile computing device 130 may execute instructions comprising applications even when disconnected from all communication links.

### Mobile Computing Device Event Systems

Returning now to FIG. 2 each mobile computing device 130, 140, 150, 160 includes a conventional event subsystem (not shown). Each event subsystem is responsible for detecting, generating and transmitting event reports for events occurring on its corresponding mobile device.

Table 1 below provides a list of example events representative of events defined for mobile devices 130, 140, 150, 160 according to embodiments of the invention.

TABLE 1

| Event Name | Description | Event Name | Description |
|---|---|---|---|
| pageOpen | A page of an open | crash | An application |
| | document was | | programming running |
| | displayed | | on a mobile device |
| | | | crashed |
| pageClose | A page displayed | downloadPaused | An application or |
| | displayed on a display | | update was |
| | of a mobile device page | | downloading and was |
| | closed | | paused. |
| buttonPress | A | downloadStarted | Download of a |
| | button on a mobile | | program or update to |
| | device was pressed | | a mobile device was |
| | (by user) | | started. |
| openDocument | A document was | installFailed | Installation of an |
| | opened | | application or update |
| | | | on a mobile device failed. |

As Table 1 indicates, events and event notifications may have information associated with them. For example, information associated with an event typically at least identifies the event type. Further information may be associated with an event including an indication of when an occurred, who or what caused it to occur, and any additional data provided by the event source to the event handler including information about how the event should be processed.

Table 2 lists example information provided in association with an example event of the type ‘subscribe’.

TABLE 2
Example Event Information

| type | subscribe |
|---|---|
| fired_at | 21:35:57″2009-03-26 |
| data[id] | 8a25ff1d98 |
| data[list_id] | a6b5da1054 |
| data[email | api@mailchimp.com |
| data[merges][FNAME] | MailChimp |
| data[merges][LNAME] | API |
| data[merges][INTERESTS | Group1, Group2 |

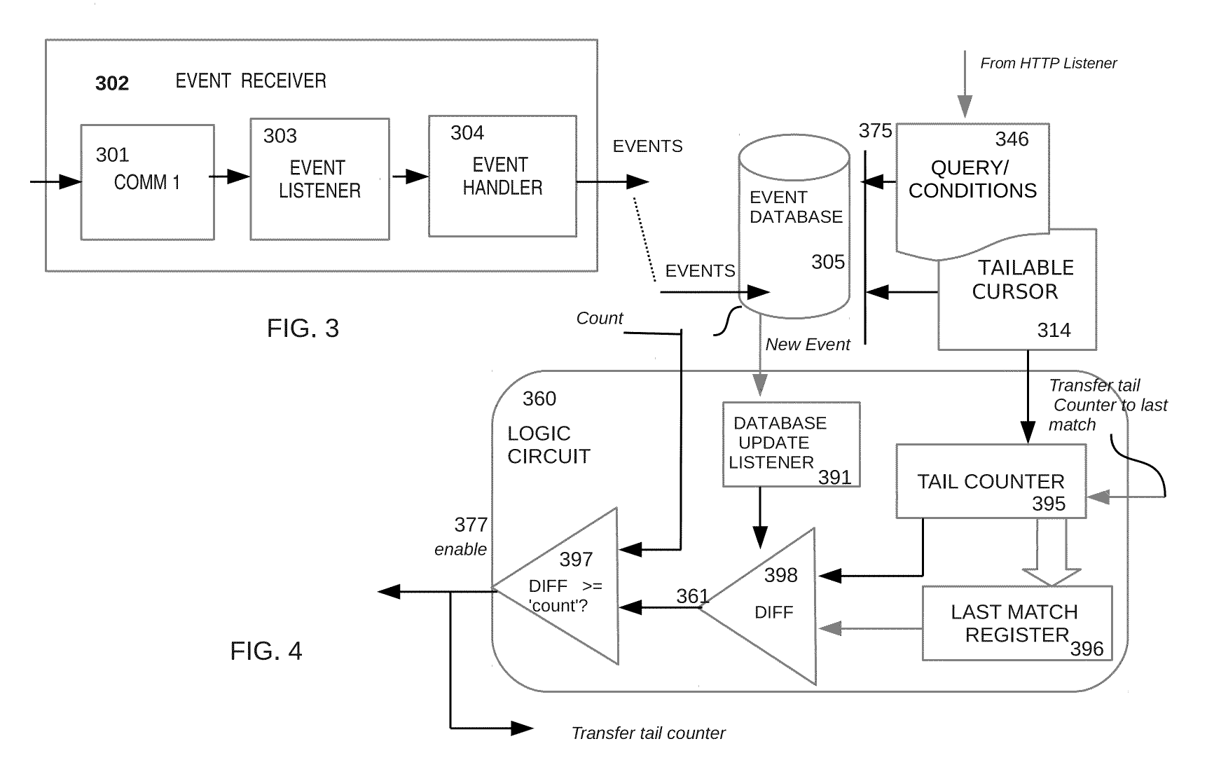

FIG. 3

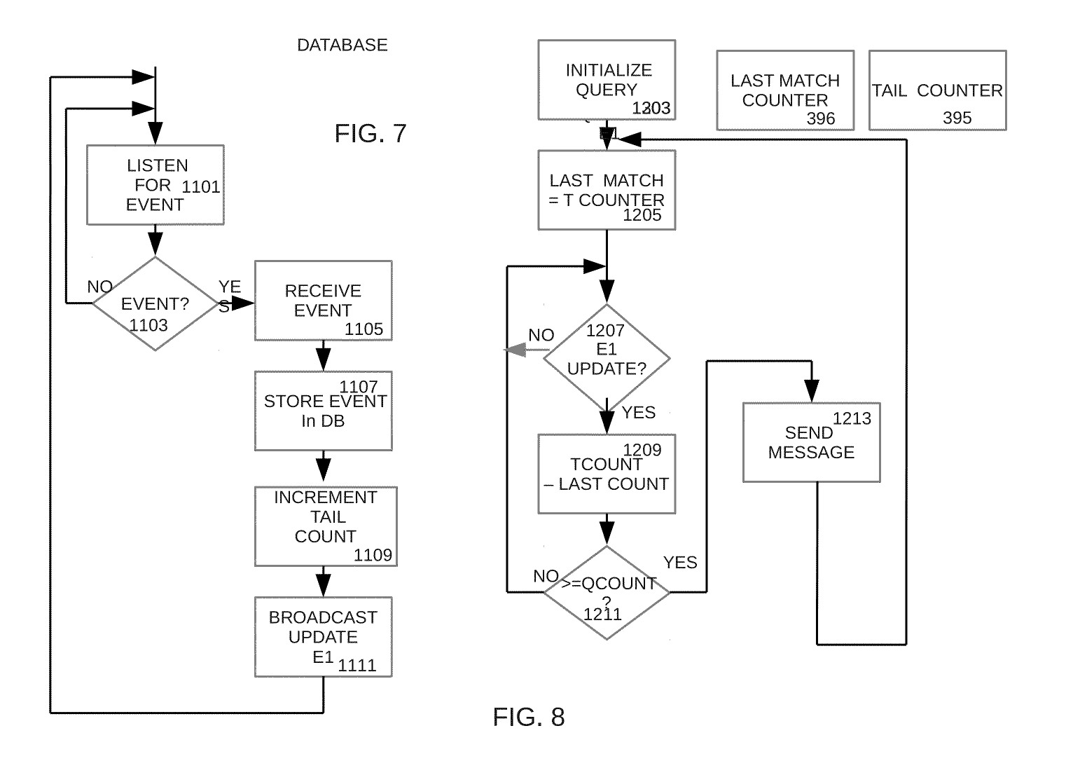

FIG. 3 is a block diagram of an event event receiver 302 of the type illustrated in FIG. 2 at 302. A corresponding method for receiving events is illustrated in FIG. 7. As illustrated in FIG. 3 a communications port 301 is configured to receive events from at least one of a plurality of mobile computing devices (illustrated in FIG. 2). For example, event receiver 302 may subscribe to events generated by a mobile computing platform.

Event notifications and event information are received at communications port 301. According to some embodiments of the invention communications port 301 is a wireless communications port configured to communicate with mobile computing devices via a GSM network, a GPRS network, an EDGE network, a Wi-Fi or WiMax network, or a Bluetooth network.

An event listener 303 is coupled to communications port 301 to receive the events transmitted by mobile computing devices. (FIG. 7 at 7101.) As events are received (FIG. 7 at 1103 output “yes”), event listener 303 notifies event handler 304 of received events. According to an embodiment of the invention event handler 304 comprises a configuration engine of the type illustrated in FIG. 2 at 313 of Event Monitor 300. Event handler 304 executes program instructions to process the events. (FIG. 7 at 1105). According to one embodiment of the invention event handler 304 forwards events to an event filter 305. In one embodiment of the invention event handler 304 forwards events to an event filter comprising an event database 305, as illustrated in FIG. 4. (FIG. 7 at 1107)

### FIG. 4

FIG. 4 is a block diagram illustrating an embodiment of an event filter 305 comprising event monitor 300 of the type illustrated in FIG. 2 at 31. Event filter 305 of the invention cooperates with logic circuit 360 to filter events received from event handler 304 in accordance with the control signal “conditions” at an input 375 of event filter 305. In the embodiment illustrated in FIG. 4, event filter 305 comprises an event database 305. According to one example embodiment of the invention database 305 is implemented using MongoDB. MongoDB is a commercially available document oriented database. However, the invention is not limited to implementation using MongoDB. As discussed below a number of commercially available databases providing tailable cursors will be suitable for implementing various embodiments of the invention.

Event database 305 includes a tailable cursor 314. A tailable cursor tails the end of a capped collection of events in event database 305. A collection of events is a collection of instances of a given event. For example, a platform-defined event E1 fires when a user opens a page of a book application on a mobile computing device 130 (illustrated in FIG. 1). When the page opens, event E1 fires at device 130. Notification of the firing of event E1 is transmitted (along with information about the event) to event receiver 302 (illustrated in FIG. 3). Event receiver 302 receives the event firing notification and if provided, event information. Event receiver 302 passes the information to event database 305. Database 305 stores the event information for this instance of E1 firing in a collection of documents associated with event E1. Each time a user opens the page defining event E1, event E1 fires at event source 130, and notification of the firing of E1 is transmitted to event database 305 via event receiver 302. The E1 event instance is stored in the E1 collection of database 305 and tailable cursor 314 increments (FIG. 7 at 1109).

As illustrated in FIG. 3 at 450, a client-defined ‘conditions’ element is included in a client request. As an illustrative example, assume client 400 (FIG. 3) has identified event E1 in the ‘conditions’ element portion of request 450. In that case, request 450 is received by request receiver 319 and provided to configuration engine 313 (FIG. 3). Configuration engine 313 parses the request and provides the condition element comprising E1 as a configuration input to event filter 305.

According to the embodiment illustrated in FIG. 4 event filter 305 comprises a database 305 and the filter configuration input to filter 305 comprises a query 346 to database 305. As illustrated in FIG. 4 and example event ‘E1’ is presented as a query 346 to event database 305. Query 346 queries database 305 for event E1.

According to the embodiment of FIG. 4, event database 305 includes a tailable cursor 314. A logic circuit 360 includes a tail counter 395. Tail counter 395 is coupled to tailable cursor 314 so as to increment tail counter 395 count with each increment of tailable cursor 314. When new E1 events arrive at event receiver 302, corresponding event handler 301 inserts each arriving E1 event in an E1 event collection of event database 305. Tailable cursor 314 tracks each insertion in the collection and with each insertion and tail counter 395 is incremented accordingly. As long as query 346 is present at input 375 of database 305, tailable cursor 314 tracks arrivals of events comprising the ‘condition’ element of request 450 (FIG. 3), e.g., event E1. In the example, tail counter 395 increments with each new arrival of E1.

The following discussion references a method of the invention illustrated in FIG. 8. According to one embodiment of the invention, tail counter 395 is initialized upon presentation of Query 346 to database 305 pursuant to receipt of a request 450 from client 400. (Initialize Query at 1203 of FIG. 8). Tail counter 395 is initialized by loading tail counter 395 with the corresponding value of tailable cursor 314 at the time of presentation of Query 346. A tailable cursor value at the time of initialization comprises a value corresponding to a top of a collection of events E1 that had fired, been notified, received and stored in database 305 before the time of initialization. For purposes of explanation herein, assume 15 events E1 have been recorded in database 305 at the time query 346 is presented to database 305.

Logic circuit 360 further comprises a ‘last match’ register 396. Last match register 396 is initialized with a value of 0. However, last match register 396 is configured with respect to tail counter 395 to receive a copy of the count comprising tail counter 395 when an enable output 377 of comparator 397 is activated (or goes to logic level 1 according to one embodiment of logic circuit 360) subsequent to initialization of last match register 396. (See FIG. 8 at 1205)

When last match register 396 is initialized, comparator 398 compares values at its inputs. Provided at one input is the count from tail counter 395. Provided at another input is the count from last match register 396. Comparator 398 provides an output signal 361 indicating the difference between the counts at its inputs. At the example time of initialization, the difference between tail counter 395 (holding a count of 15) and last match register 396 (initialized to 0) comprises ‘15’, i.e., the number of events E1 stored in database 305 at the time query 346 is presented to database 305.

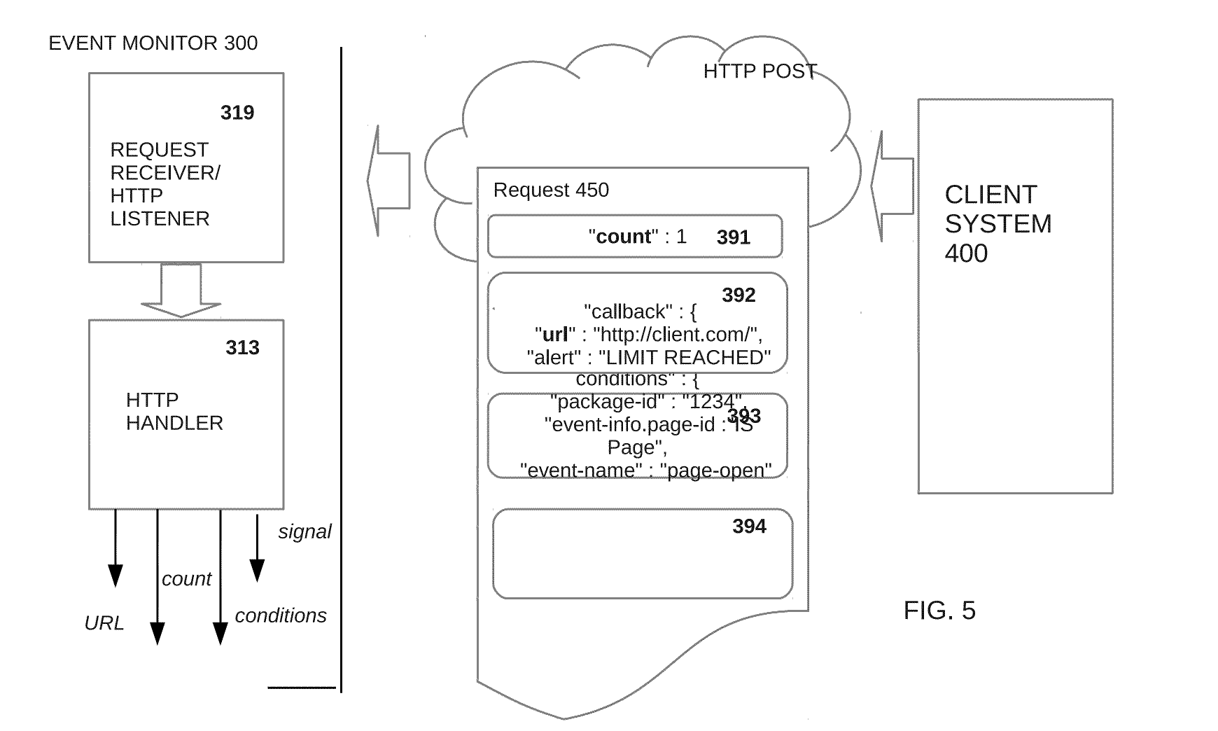

The difference value ‘15’, is provided at an input to a second comparator 397. The other input to comparator 397 is the client defined value contained in the ‘count’ element of request 450 (best illustrated in FIG. 5 at 450). Comparator 397 determines whether the output of comparator 398 is greater than the the ‘count’ value. Assume for purposes of discussion the client-defined ‘count’ value comprising request 450 is ‘2’. In that case the output of comparator 398 is greater than 2. As a result, the output 377 of comparator 397 activates (or goes to logic level 1 according to one implementation of logic circuit 360).

When the output of comparator 397 activates, the value in tail counter 395 (‘15’) is copied to last match register 396. (See FIG. 8 at 1205) Accordingly the output of comparator 398 goes to 0. Likewise the output of comparator 397 deactivates (e.g., goes to 0 according to a logic arrangement of an example embodiment of the invention) since the 0 value on one of its inputs is not greater than the count of 2.

According to one embodiment of the invention, storage of each new event in event database 305 is detected and broadcast by update listener 391. (FIG. 7 at 1111). Event update listener 391 responds to each new entry by providing an enable signal to comparator 398, enabling comparator 398 to compare the values at its inputs. (See FIG. 8 at 1209). According to one example arrangement, if the arriving event is not an E1 event, tail counter 395 does not increment and the output of comparator 398 does not change. If the arriving event comprises an E1 event, tailable cursor 314 increments by 1 (from 15 to 16). Likewise the value of tail counter 395 increments from 15 to 16.

Accordingly, the input to comparator 398 from tail counter 395 updates to ‘16’. The input to comparator 398 from last match register 396 remains at the ‘last match’ count, in this example ‘15’. Accordingly, a difference count of ‘1’ appears at output 361 of comparator 398. Comparator 397 compares the difference count 1 with the count ‘2’ comprising the ‘count’ element of request 450. At this point in the example, difference count 1 is not greater than or equal to ‘count’ (2) comprising request 450. Thus, the output of comparator 307 is not activated, i.e., remains ‘0’.

Upon the arrival of the next respective update of database 305 with an event E1 (FIG. 8 at 1207 “yes” output) tail counter 395 increments from 15 to 16. The difference (DIFF) between tail counter 395 and last match register 396 at output 361 increases to 2. (FIG. 8 at 1209). At comparator 397 the difference (DIFF) ‘2’ is tested to determine if DIFF meets the condition “greater than or equal to ‘count’. (FIG. 8 at 1211) In the example, DIFF is 2 and the output 377 of comparator 397 will be activated (e.g., changes to logic 1). (FIG. 8 at 1211, “yes”)

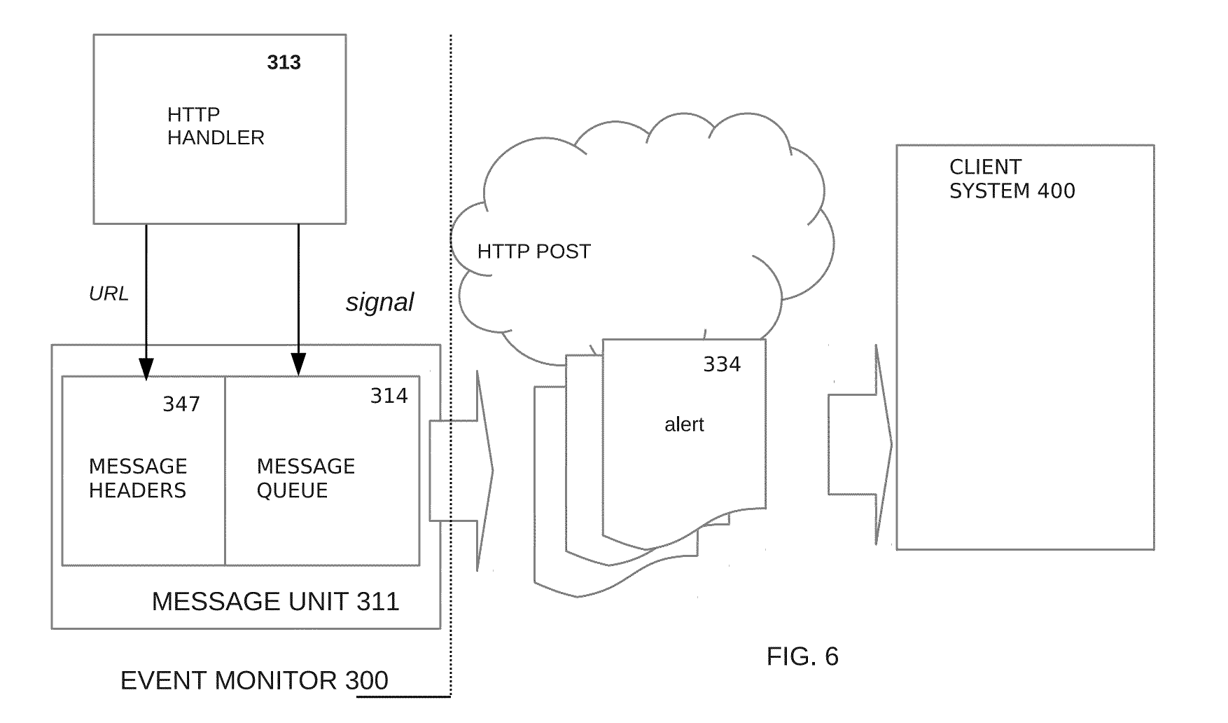

In turn the ‘transfer’ enable signal of tail counter 395 will activate, copying the contents of tail counter 395 to last match register 396. (FIG. 8 at 1205). The output of comparator 397 is also provided to a message unit (of the type illustrated at 311 in FIG. 6, enabling the message unit to provide a client-defined alert to client 400 (FIG. 8 at 1213).

Reaching the ‘count’ defined by the count element comprising request 450 results in Event Monitor 300 returning an alert to client 400. Reaching the count further results in a ‘reset’ of logic circuit 360 such that the next client-defined alert is sent to client 400 only when the number of arrivals of event E1 once again reaches the value comprising ‘count’ of request 450.

### FIG. 5

FIG. 5 illustrates a request receiver 319 of an embodiment of event monitor 300 of the type illustrated in FIG. 2 at 319. According to an embodiment of the invention request receiver 319 comprises an HTTP listener configured to listen for requests 450 comprising HTTP posts from client 400. An output of request receiver 319 is coupled to a configuration engine 319 comprising a corresponding HTTP handler.

Upon detecting an HTTP request from client 400. Request receiver 319 receives requests 450 from Client system 400 for reports or ‘alerts’ about events. The frequency at which event monitor 300 provides the requested reports/alerts is related (by ‘count’) to the frequency of occurrence of the conditions (events) identified in field 393 of request 450. In that regard, the ‘conditions’ element 393 of request 450 in cooperation with the count provided in count element 391 define a new event. The new event E′ occurs upon the arrival of an existing event E at the end of each interval defined by ‘count’. When the new event E′ occurs, event monitor 300 sends an alert to client 400.

Client 400 defines the contents of the alert it will receive from event monitor 300 within request 450. In the example shown in FIG. 5 the text of the alert comprises “LIMIT REACHED”, as illustrated at 392. However, this text is for illustration purposes only. Any text, image, sound, etc. desired by client 400 to comprise an alert may be provided in element 392 of request 450.

Client system 400 defines ‘conditions of interest’ by providing “conditions” in the conditions element 393 of request 450. The ‘conditions’ element identifies at least one existing event defined for a mobile computing device. Client system 400 provides a ‘count’ in the count element of request 450. The count element defines a ratio relating the number of reports returned to client 400 to the number of arriving notifications for the event defined in the “conditions” portion of request 450. For example, a count of 1 results in a report returned every time event database 305 (illustrated in FIG. 4) updates with an arriving event matching the event defined in ‘conditions“. A count of 2 results in a report returned every other time event database 305 updates with an event matching the event defined in ‘conditions’.

Request 450 is provided to event monitor 300 as an HTTP Post. HTTP listener 319 detects the HTTP post from client system 400 and passes the count, callback and conditions elements of the request to HTTP handler 313. HTTP handler 313 parses the request and applies each element to a corresponding component of event monitor 300.

According to the example illustrated in FIG. 3 HTTP Handler 313 provides the following outputs: Uniform Resource Locator (URL), count, conditions and signal.

### FIG. 6

FIG. 6 illustrates an example message unit 311 according to an embodiment of the invention. Message unit 311 comprises a message header unit 347 and a message queue 314. In one embodiment of the invention message queue 314 is implemented using ‘RabbitMQ. RabbitMQ is an open source message broker, or message-oriented middleware, program implementing the Advanced Message Queuing Protocol (AMQP) standard.

An HTTP handler 313 comprises a configuration engine of a type illustrated and described in connection with FIG. 2. HTTP handler 313 provides a URL signal comprising a client-created callback element of message 450 to message header unit 347. The URL signal configures message header unit 347 to provide an address comprising a client-defined URL for messages comprising client-defined alerts to be returned to client 400. A ‘signal’ output of HTTP handler 313 configures message queue 314 to provide a client-defined alert 334 as a message to client system 400.

Message Unit 311 holds alerts provided by HTTP handler 313 in message queue 311 until the client defined conditions and count are met. In that case, the ‘signal portion of request 450 comprises text of a message 334 comprising alert 334 returned to the client 400.

### FIG. 7

FIG. 7 is a flowchart illustrating steps of a method for receiving events according to an embodiment of the invention. FIG. 7 is discussed in further detail with reference to the discussion of event receiver 302, illustrated in FIG. 4. In summary, at 1101 an event listener listens for events from mobile devices. If an event is detected at 1103, an event handler receives the event (at 1105) and stores the received event in a database (at 1107). For each received event a tail counter is incremented, at 1109. The update is broadcast at 1111 and the method returns to step 1107 and repeats with the arrival of the next event.

### FIG. 8

FIG. 8 is a flowchart illustrating steps of a method for counting events to implement a message rule according to an embodiment of the invention. The method illustrated in FIG. 8 is discussed with respect to the function of Logic Circuit 360 and Event Database 305 of FIG. 4.

### FIG. 9

FIG. 9 illustrates a method for configuring an Event Monitor according to an embodiment of the invention. The method illustrated in FIG. 9 is discussed with reference to the function of configuration engine 313 corresponding to FIG. 2.

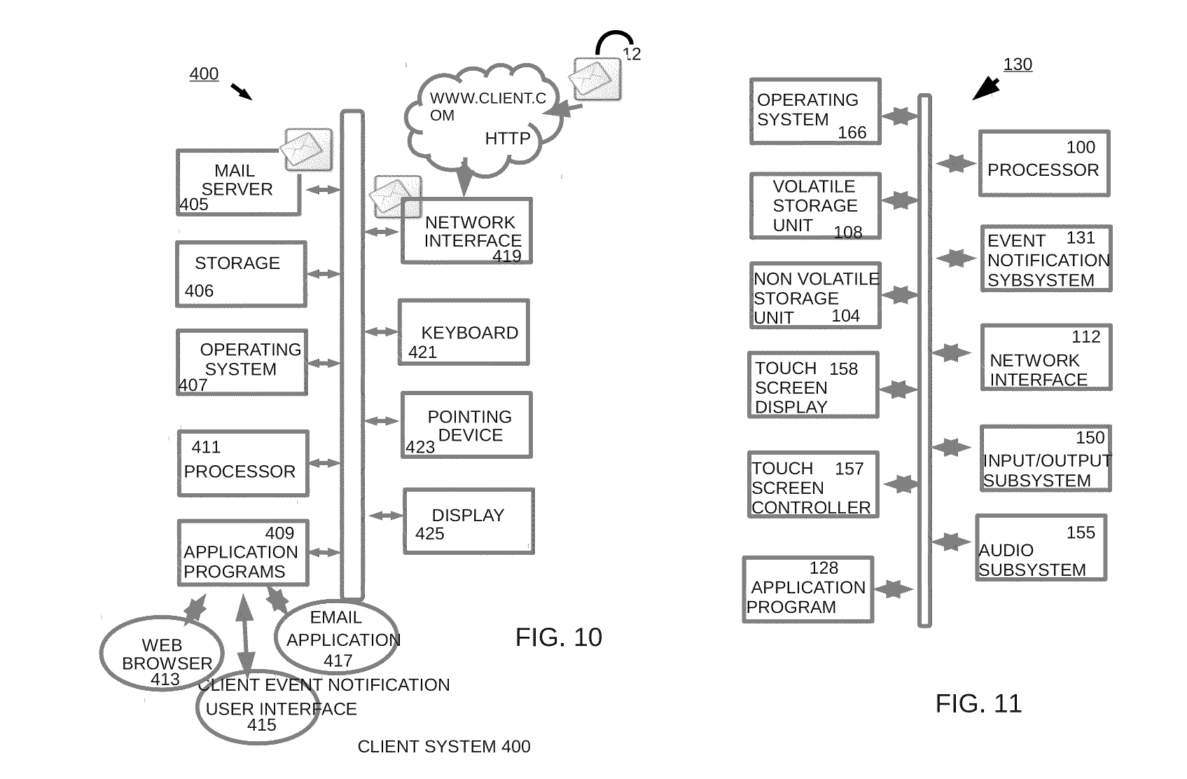

### FIG. 10

FIG. 10 is a block diagram of an example client system 400 suitable for implementing various embodiments of the invention. Client system 400 comprises conventional user interface devices, for example, keyboard 421, pointing device 423 and display 425. Client system 400 further comprises a network interface adapter 419 configured for communication via the Internet. Requests from client 400 are posted via network interface 419 using a Hypertext Text Transfer Protocol (HTTP). Client 400 may include a mail server 405 configured to receive messages at an address specified by a Uniform Resource Locater (URL).

Client 400 further comprises a processor 411 configured to execute instructions stored in a memory 406. An operating system 407 performs low level interface functions for processor 411 by which processor 411 executes application programs stored in a program memory 409. Examples of applications include a web browser application 413, a client Event Monitor Configuration Interface 415, which may comprise a graphical user interface by which a user of client system 400 generates messages 450. Client system 400 may further comprise an email client application 417.

### FIG. 11

FIG. 11 is a block diagram of an example mobile computing device of the type illustrated in FIG. 2 at 130 suitable for use with various embodiments of the invention. The components of FIG. 11 are discussed in detail above in connection with FIG. 2.

Thus there have been provided systems and methods for dynamically reconfiguring an event monitor in accordance with various embodiments of the invention.

1.-9. (canceled)

10. A computer-implemented method, said method comprising:
receiving an electronic request, at an event monitor system, said request comprising a client-defined event for monitoring;
tracking, at said event monitor system, a plurality of event occurrences received from a plurality of mobile devices;
filtering, at said event monitor system, instances of an occurrence of said client-defined event from said plurality of event occurrences;
counting, at said event monitor system, the number of instances of said occurrence of said client-defined event;
determining, at said event monitor system, whether the number of instances of said occurrence of said client-defined event has reached a threshold value; and
triggering, at said event monitor system, at least one action in real-time when said threshold value is reached.

11. The computer-implemented method of claim 10, wherein said request further comprises configuration parameters associated with said client-defined event.

12. The computer-implemented method of claim 11, wherein said configuration parameters specify one or more client-defined conditions associated with filtering instances of said occurrence of said client-defined event.

13. The computer-implemented method of claim 11, wherein said configuration parameters specify one or more client-defined threshold values associated with counting instances of said occurrence of said client-defined event.

14. The computer-implemented method of claim 11, wherein said configuration parameters specify one or more client-defined action types to be triggered when said threshold value representative of instances of said occurrence of said client-defined event is reached.

15. The computer-implemented method of claim 10, wherein said action triggered is a transmission of an alert message associated with said client-defined event.

16. The computer-implemented method of claim 10, wherein said action triggered is a software update to an application associated with said client-defined event.

17. The computer-implemented method of claim 16, wherein said action triggered is a distribution of said software update to said application associated with said client-defined event.

18. The computer-implemented method of claim 10, wherein said action triggered is a change in presentation of content in an application associated with said client-defined event.

19. The computer-implemented method of claim 10, wherein said action triggered is an analytical assessment of data representing user-behavior associated with said client-defined event.

20. The computer-implemented method of claim 10, further comprising logging user behavior associated one or more of said plurality of mobile devices.

21. An event monitor system, comprising:
an event filter configured to identify instances of an occurrence of a client-defined event from a plurality of event occurrences;
an event counter configured to count the number of instances of said occurrence of said client-defined event; and
a message unit configured to trigger at least one action in real-time when a determination is made that the number of instances of said occurrence of said client-defined event has reached a threshold value.

22. The event monitor system of claim 21, wherein said plurality of event occurrences is received from a plurality of mobile devices.

23. The event monitor system of claim 21, wherein said client-defined event is received via a request from a client-based system.

24. The event monitor system of claim 21, wherein said event filter is adapted to receive configuration parameters associated with said client-defined event, said configuration parameters specifying one or more client-defined threshold values associated with counting said occurrence of said client-defined event.

25. The event monitor system of claim 21, wherein said message unit is adapted to receive configuration parameters associated with said client-defined event, said configuration parameters specifying one or more client-defined action types to be triggered when said threshold value representative of instances of said occurrence of said client-defined event is reached.

26. The event monitor system of claim 21, wherein said action triggered by said message unit is a transmission of an alert message associated with said client-defined event.

27. The event monitor system of claim 21, wherein said action triggered by said message unit is a software update to an application associated with said client-defined event.

28. The event monitor system of claim 21, wherein said action triggered by said message unit is a change in presentation of content in an application associated with said client-defined event.

29. The event monitor system of claim 21, wherein said action triggered by said message unit is an analytical assessment of data representing user-behavior associated with said client-defined event.

30. A non-transitory computer-readable storage medium programmed to include instructions that, when executed by a processing device, cause the processing device to perform a method, said method comprising:
receiving an electronic request, at an event monitor system, said request comprising a client-defined event;
tracking, at said event monitor system, a plurality of event occurrences received from a plurality of mobile devices;
filtering, at said event monitor system, instances of an occurrence of said client-defined event from said plurality of event occurrences;
counting, at said event monitor system, the number of instances of said client-defined event;
determining, at said event monitor system, whether the number of instances of said client-defined event counted has satisfied a pre-determined threshold value; and
triggering, at said event monitor system, at least one action in real-time when said pre-determined threshold value is satisfied.
